(19) United States
(12) Patent Application Publication
(10) Pub. No.: US 2013/0063338 A1
(43) Pub. Date: Mar. 14, 2013

(54) DISPLAY WITH SCREEN CAPTURE FUNCTION

(71) Applicant: ZHEN-XING MA, Shenzhen City (CN)

(72) Inventor: ZHEN-XING MA, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/283,612

(22) Filed: Oct. 28, 2011

(30) Foreign Application Priority Data
Sep. 8, 2011 (CN) 201110265567.8

(51) Int. Cl. G09G 5/00

(52) U.S. Cl. 345/156

(57) ABSTRACT

A display includes an input interface, a circuit board, a display panel, and an external memory. The input interface is electrically connected to a computer, and receives an image signal from the computer. The image signal includes a number of frames of image data. The circuit board includes a main control chip, an image processing module, and a recall button. The main control chip drives the display panel to display the frames of image data sequentially. If the computer freezes, the main control chip will control the display panel to repeatedly display a final frame of image data. When the recall button is pressed, the image processing module codes/decodes a frame of image data currently displayed on the display panel to obtain image data in a predetermined format which is stored in the external memory.

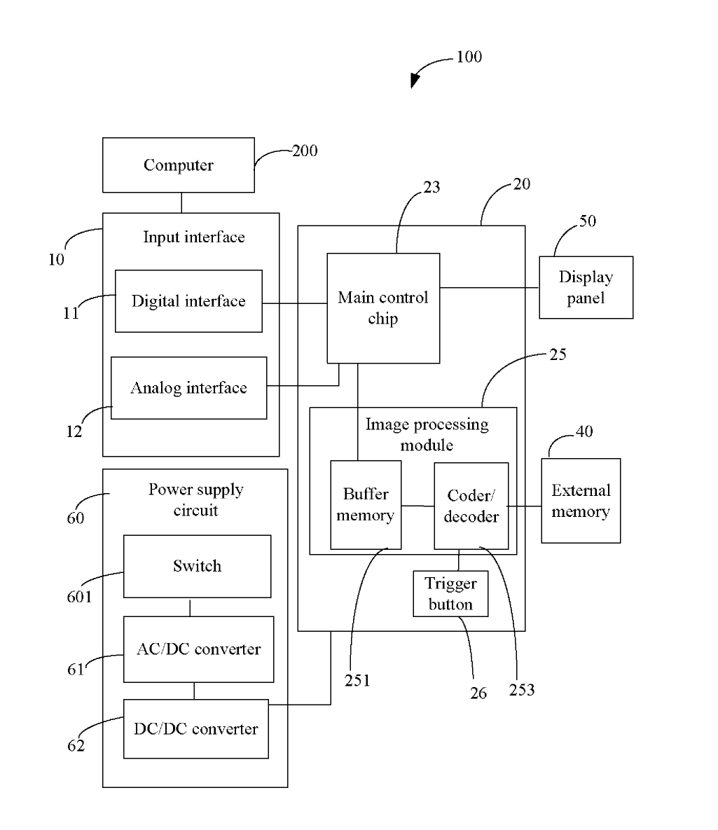

### BACKGROUND

1. Technical Field

The present disclosure relates to a display with a screen capture function.

2. Description of Related Art

During boot up of a computer, the computer may freeze because of a program error that causes an error message detailing the program error to be displayed on a display electrically connected to the computer. Capturing the error message is useful; however, because the frozen computer does not typically respond to any input instruction from an external input device (such as a keyboard or mouse), it is impossible to capture the error message and recording it otherwise is inconvenient. Using a camera to capture the image is very inconvenient.

Therefore, it is desirable to provide a display with screen capture function that can overcome the above-mentioned limitations.

### BRIEF DESCRIPTION OF THE DRAWINGS

Many aspects of the embodiments may be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

The figure is a schematic functional block diagram of a display, according to an exemplary embodiment.

### DETAILED DESCRIPTION

Referring to the figure, a display 100, according to an exemplary embodiment, includes an input interface 10, a circuit board 20, an external memory 40, a display panel 50, and a power supply circuit 60.

The input interface 10 is electrically connected to a computer 200, and is configured for receiving an image signal from the computer 200. The image signal includes a number of frames of image data. The image signal may be a digital signal or an analog signal. The input interface 10 includes a digital interface 11 and an analog interface 12. The digital interface 11 is configured for receiving digital signals from the computer 200. The analog interface 12 is configured for receiving analog signals from the computer 200. In one exemplary embodiment, the digital signal is a transition-minimized-differential-signaling (TMDS) signal and the analog signal is a video-graphics-array (VGA) signal.

The circuit board 20 includes a main control chip 23, an image processing module 25, and a recall button 26. The main control chip 23 is electrically connected to the input interface 10 and is configured for receiving the image signal from the input interface 10, and driving the display panel 50 to display frames of image data sequentially. If the computer 200 freezes (e.g., does not respond to external commands from an input device) during boot up of the computer 200, the computer 200 will repeatedly output a final frame of image data to the main control chip 23, and thus the main control chip 23 will control the display panel 50 to repeatedly display the final frame of image data. The final frame of image data can be an error message that details reasons of why the computer froze during boot up of the computer 200. It should be understood that the image data may comprise multiple sequential image frames that when joined, forms a single cohesive image.

The image processing module 25 includes a buffer memory 251 and a coder/decoder 253. The buffer memory 251 is electrically connected to the main control chip 23 and is configured for receiving and storing the frames of image data which is from the main control chip 23 and have been displayed on the display panel 50. In particularly, when the main control chip 23 receives a frame of image data from the input interface 10, the main control chip 23 will automatically duplicate the frame of image data to obtain two frames of image data same as each other. When one of the two frames of image data is sent to the display panel, at the same time, the other one of the two frames of image data is sent to the buffer memory 251.

The coder/decoder 253 is electrically connected to the buffer memory 251 and the recall button 26. The recall button 26 is configured for activating the coder/decoder 253. When the recall button 26 is pressed, the coder/decoder 253 codes/decodes a frame of image data currently received from the main control chip 23 (i.e. the final frame of image data), and thus to obtain image data in a predetermined format. In one exemplary embodiment, the predetermined format is the joint photographic experts group (JPEG) format. The coder/decoder 253 is an AD1835AASZ chip.

The external memory 40 is electrically connected to the coder/decoder 253, and is configured for storing the image data in the predetermined format from the coder/decoder 253. In one exemplary embodiment, the external memory 40 is a portable hard drive.

The display panel 50 is electrically connected to the main control chip 23. In one exemplary embodiment, the display panel 50 is a liquid crystal display (LCD). The recall button 26 is positioned on the display panel 50.

The power supply circuit 60 is electrically connected to the circuit board 20, and includes a switch 601, an alternating current/direct current (AC/DC) converter 61, and a direct current/direct current (DC/DC) converter 62. The AC/DC converter 61 is electrically connected to an external power supply (not shown) through the switch 601, and is configured for converting the external AC into DC. The DC/DC converter 62 is electrically connected to an output of the AC/DC converter 61 and is configured for converting the DC from the AC/DC converter 61 into a number of DC voltages, and providing the different DC voltages to the circuit board 20.

In use, when the display panel 50 repeatedly displays a final frame of image data, a user may determine that the computer 200 is frozen, then the user presses the recall button 26, the coder/decoder 253 may code/decode the frame of image data currently received from the main control chip 23, to obtain the image data in the predetermined format, and the image data in the predetermined format is stored in the external memory 40.

It will be understood that the above particular embodiments and methods are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A display comprising:
a display panel;
a recall button;
an input interface electrically connected to a computer, and configured for receiving an image signal from the computer, wherein the image signal comprises a plurality of frames of image data;
a circuit board comprising:
a main control chip electrically connected to the input interface and configured for receiving the image signal and driving the display panel to display the frames of image data sequentially, wherein the main control chip repeatedly receives a final frame of image data from the computer when the computer is freezes, and control the display panel to repeatedly display the final frame of image data;
an image processing module comprising:
a buffer memory electrically connected to the main control chip and configured for receiving and storing the frames of image data from the main control chip; and
a coder/decoder electrically connected to the buffer memory and the recall button and configured for coding/decoding the frame of image data currently received from the main control chip when the recall button is pressed; and
an external memory electrically connected to the coder/decoder and configured for storing the image data in a predetermined format.

2. The display in claim 1, wherein the coder/decoder 253 is an AD1835AASZ chip.

3. The display in claim 1, wherein the predetermined format is the joint photographic experts group (JPEG) format.

4. The display in claim 1, wherein the recall button is positioned on the display panel.

5. The display in claim 1, wherein the image signal is a digital signal or an analog signal, the digital signal is a transition-minimized-differential-signaling signal, the analog signal is a video-graphics-array signal.

6. The display of claim 5, wherein the first image signal is a digital signal or an analog signal, the input interface comprises a digital signal interface and an analog interface, the digital interface is configured for receiving the digital signal from the computer, the analog interface is configured for receiving the analog signal from the computer.

7. The display in claim 1, wherein the display further comprises a power supply circuit, the power supply circuit is electrically connected to the circuit board, and comprises a switch, an AC/DC converter, and a DC/DC converter, the AC/DC converter is electrically connected to an external power supply and configured for converting the external AC voltage into DC voltage, the DC/DC converter is electrically connected to an output of the AC/DC converter and configured for converting the DC voltage from the AC/DC converter into a plurality of different DC voltages, and providing the different DC voltages to the circuit board.

8. The display in claim 1, wherein the display panel is a liquid crystal display.

9. The display in claim 1, wherein the external memory is a portable hard drive.
